(19) United States
(12) Patent Application Publication
(10) Pub. No.: US 2007/0094439 A1
(43) Pub. Date: Apr. 26, 2007

(54) Expandable portable solid-state device & method

(75) Inventors: Santosh Kumar, San Jose, CA (US); Soummya Mallick, Fremont, CA (US)

Correspondence Address: LAW OFFICES OF JAMES E. EAKIN, P.O. Box 1250, Menlo Park, CA, 94025, US

(73) Assignee: xipkey, Inc.

(21) Appl. No.: 11/254,353

(22) Filed: Oct. 20, 2005

(51) Int. Cl. G06F 12/00

(52) U.S. Cl. 711/103

(57) ABSTRACT

Apparatuses and methods of an expandable portable solid-state device are disclosed. In one embodiment, a solid-state device includes an expansion canister to enable coupling of a flash memory of the solid-state device to an external storage memory, and an executable-in-place module of the solid state device coupled to the flash memory to process a swap data to minimize a number of write operations in the flash memory. The executable-in-place module may include a secondary flash memory coupled to a dynamic random access memory. The dynamic random access memory may store at least as much data as the secondary flash memory. A logic circuit coupled to the secondary flash memory and the dynamic random access memory may copy data from the secondary flash memory to the dynamic random access memory on power up of a data processing system coupled to the solid-state device.

### FIELD OF TECHNOLOGY

This disclosure relates generally to the technical fields of storage devices, flash devices, random access memory devices, and in one example embodiment, to an expandable portable solid-state device and method.

### BACKGROUND

Since storage space on a flash drive (e.g., a device having a flash memory) is limited, when a user has utilized the storage space on the flash drive (e.g., 250 megabytes), the user may choose to discard the flash drive, and may purchase a new flash drive with larger storage capacity (e.g., 500 megabytes, though in the future may be larger). The flash memory is a form of rewritable memory device that, unlike a Random Access Memory device, holds its content without requiring connection to a power supply. The flash memory is made in two forms: a NOR-type flash memory and a NAND-type flash memory and a NAND-type flash memory. The NAND-type flash memory has faster erase and write times, higher density, and lower cost per-bit than the NOR-type flash memory, and ten times the endurance. This makes the NAND-type flash memory suitable for mass-storage devices such as PC cards and various memory cards.

The flash drive (e.g., a type of solid-state device) is essentially the NAND-type flash memory integrated with an interface (e.g., a USB) and used as a small, lightweight, removable data storage device. The flash drive is also known as “a pen drive”, “a thumb drive”, “a flash device”, “a USB key”, “a USB memory key”, “a USB stick”, “a jump drive”, “a key drive” and many more names. The flash drive may be active only when powered by a USB computer connection, and may require no other external power source or battery power source (e.g., may run off a limited supply afforded by a USB interface). To access data stored in the flash drive, the flash drive can be connected to a computer, either by a direct connection to the computer's USB port or via a USB hub.

The flash drive is resistant to scratches and dust that plagued previous forms of storage like hard drives, compact discs, and floppy disks. Furthermore, the flash drive may be up to 1,000 times faster than hard drives (e.g., according to current speeds, in the future may be different), compact discs, and floppy disks. A solid-state design of the flash drive means that it may survive some accidents (e.g., an impact, a drop, a crush, a water damage, a coffee spill, etc.). This makes the flash drive ideal for transporting personal data and/or work files from one location to another (e.g., from home to school or office) and/or for carrying around personal data that the user typically wants to access in a variety of places.

The flash drive may consist of a small printed circuit board encased with a robust plastic casing, making the drive sturdy enough to be carried around in a pocket, as a keyfob (e.g., a decorative item which many people carry with their keys, on a ring or a chain, often to provide a better grip or to simply make a personal statement), or on a lanyard (e.g., a rope or a cord often worn around a neck or wrist to carry something). A USB (e.g., type ‘A’ USB or a mini-USB) connector may protrude from a plastic protection encompassing the flash drive and may be covered by a removable plastic cap.

The flash drive however can sustain only a limited number of write/erase cycles before failure. This limits an ability of the flash drive to execute in place (e.g., to run application software such as Microsoft® Word®, Microsoft® Excel®, Adobe® Photoshop®, etc. requiring numerous read/write sequences during operation). Also, this limits the flash drive from running many popular operating systems (e.g., Microsoft® Windows®, Apple® MacOS®, etc.) typically operable on the hard drive.

### SUMMARY

Apparatuses and methods of an expandable portable solid-state device are disclosed. In one aspect, a solid-state device includes an expansion canister to enable coupling of a flash memory of the solid-state device to an external storage memory, and an executable-in-place module of the solid state device coupled to the flash memory to process a swap data to minimize a number of write operations in the flash memory. The executable-in-place module may include a secondary flash memory coupled (e.g., connected) to a dynamic random access memory. The dynamic random access memory may store at least as much data as the secondary flash memory. A logic circuit may be coupled to the secondary flash memory and the dynamic random access memory to copy data from the secondary flash memory to the dynamic random access memory on power up of a data processing system coupled (e.g., connected) to the solid-state device.

The logic circuit may minimize writes to the secondary flash memory by using the dynamic access memory as a working memory during operation of the data processing system. The logic circuit may block at least some sectors of the secondary flash memory and/or the dynamic random access memory when the data processing system uses the working memory to conserve power usage of the solid-state device. The logic circuit may transfer all data in the dynamic random access memory to the flash memory and/or the secondary flash memory on power down of the data processing system.

A liquid crystal display may indicate that the solid-state device is operable when data of the secondary flash memory is copied to the dynamic random access memory. In addition, a capacitor of the executable-in-place module may retain at least some data of the flash memory in the dynamic random access memory upon power down of the data processing system. The logic circuit may copy sectors from the secondary flash memory in an order based on a prior history of data access by the data processing system. The external storage memory may be in the form of a universal serial bus (USB) hard drive coupled through the expansion canister (e.g., the solid-state device may be coupled to the data processing system through a USB connector). The solid-state device may be a portable device (e.g., a keyfob and/or a lanyard) external to the data processing system. The solid-state device may be packaged to withstand heat at least until 125 degrees Celsius, and may have a mean time between failures of 3 million hours. Application programs may be executed directly from the solid-state device without customized optimization of the solid-state device. A driver of the data processing system may instruct the data processing system to boot up the data processing system from an operating system whose read-only data is executable from the flash memory and whose swap data is executable from the executable-in-place module. The driver may be automatically loaded on the data processing system when the solid-state device is connected to the data processing system.

In another aspect, a method includes dynamically constructing a memory map when an expansion canister detects a presence of an expansion memory, allocating a read-only portion of an executable data to the expansion memory and/or a primary flash memory, and allocating a swap data of the executable data to an executable-in place module. The read-only portion and the swap data may be allocated in a predetermined order based on a prior history of access by a data processing system, and the data processing system may begin accessing data of the executable-in-place module upon boot up of the data processing system.

In yet another aspect, a method of a data processing system includes providing power to an expandable portable solid-state device external to the data processing system through a USB interface, redirecting a boot process of the data processing system to an executable-in-place module of the expandable portable solid-state device based on a driver installed in a storage device of the data processing system, processing at least some swap data on a proxy memory of the executable-in-place module(e.g., the proxy memory may be at least as large as a secondary flash memory of the executable-in-place module and may contain a mirror image of data of the secondary flash memory), and processing at least some read-only data on a primary storage memory (e.g., a primary internal flash memory and/or an expansion memory). The expansion memory may be concatenated to the primary internal flash memory to provide security to data of the expandable portable solid-state device. In addition, the expansion memory may a separate logical volume to the primary internal flash memory to provide flexibility to the expandable portable solid-state device.

Other features of various embodiments will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements and in which:

FIG. 1 is a system view of an expandable portable solid-state device coupled to a data processing system, according to one embodiment.

FIG. 2 is a block diagram of the expandable portable solid-state device of FIG. 1 having an executable-in-place module, a flash memory, an expansion canister, and an expansion memory, according to one embodiment.

FIG. 3 is an exploded view of the executable-in-place module having a flash memory, a dynamic random access memory, a custom circuit, a memory controller, and an interface, according to one embodiment.

FIG. 4 is a logic circuit view of the custom circuit of FIG. 3 having a pre-fetch circuit, a power management circuit, a load register circuit, an output register circuit, and a capacitor coupled to a command arbitration circuit, according to one embodiment.

FIG. 5 is a logic view of a dynamic virtualization map associated with the executable-in-place module, a solid-state module, and an expansion module, according to one embodiment.

FIG. 6 is a segmentation view of an allocation of swap data to the executable-in-place module and an allocation of read-only data to the solid-state module and/or the expansion module, according to one embodiment.

FIG. 7 is a diagrammatic representation of a machine in an example form of a computer system in which there are a set of instructions, for causing the machine to perform any one or more of the methodologies discussed herein may be executed, according to one embodiment.

FIG. 8 is a process flow to dynamically construct a memory map, according to one embodiment.

FIG. 9 is a process flow to redirect a boot process of a data processing system to an executable-in-place module, according to one embodiment.

Other features of the present embodiments will be apparent from the accompanying drawings and from the detailed description that follows.

### DETAILED DESCRIPTION

Apparatuses and methods of an expandable portable solid-state device are disclosed. In the following description, for purposes of explanation, numerous specific details are set forth in order to provide a thorough understanding of the various embodiments. It will be evident, however, to one skilled in the art that the various embodiments may be practiced without these specific details. It is to be understood that other embodiments may be utilized and that changes may be made without departing from the scope of the various embodiments. It will be appreciated that the various embodiments discussed herein may/may not be the same embodiment, and may be grouped into various other embodiments not explicitly disclosed herein. The following detailed description is, therefore, not to be taken in a limiting sense, and the scope of the present embodiments is defined only by the appended claims.

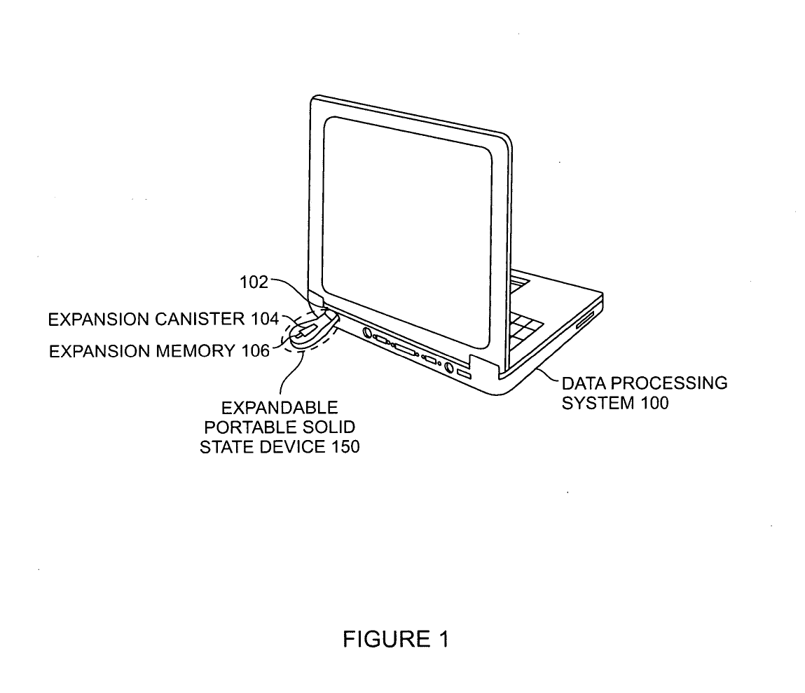

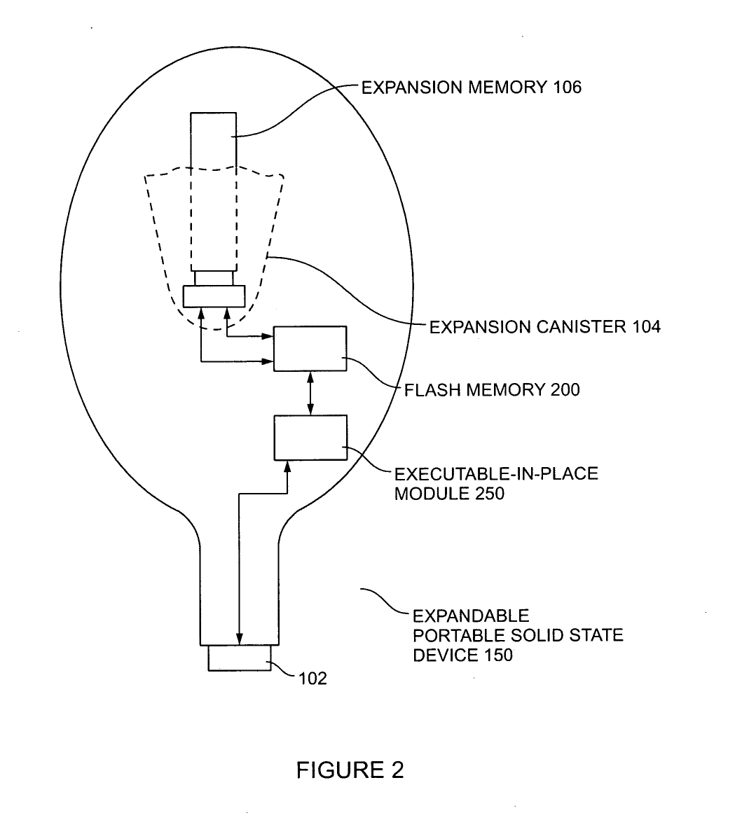

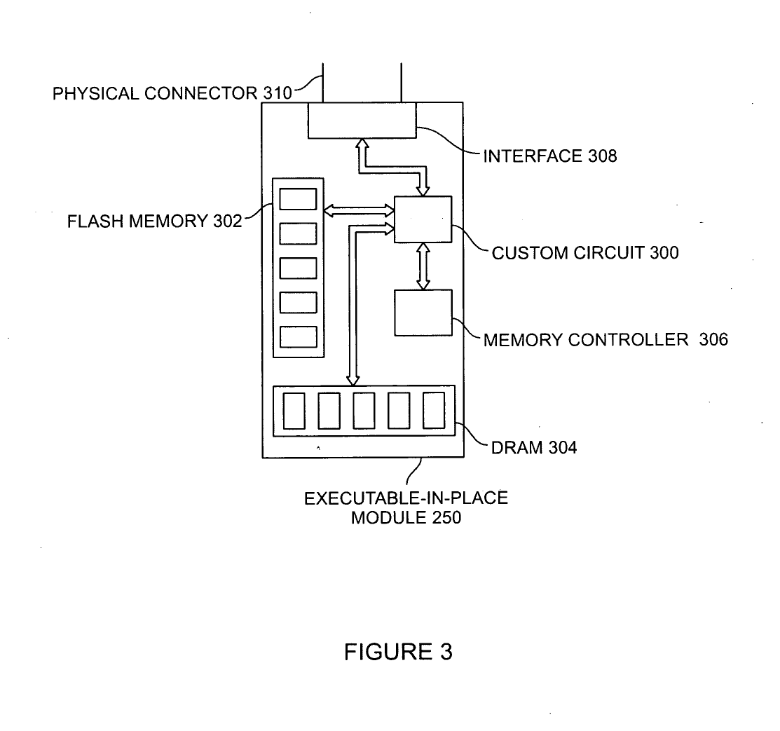

FIG. 1 is a system view of an expandable portable solid-state device 150 coupled to a data processing system 100, according to one embodiment. In FIG. 1, the data processing system 100 (e.g., a laptop computer, a desktop computer, etc.) is coupled (e.g., connected) to the expandable portable solid-state device 150. The expandable portable solid-state device 150 is “executable-in-place” (e.g., able to run application software such as Microsoft® Word®, Microsoft® Excel®, Adobe® Photoshop®, etc. requiring numerous read/write sequences during operation) partly because it includes an executable-in-place module 250 illustrated in an exploded view of the expandable portable solid-state device 150 in FIG. 2 (e.g., the executable-in-place module 250 may have a dynamic random access memory 304 that is at least as large as a flash memory 302 (e.g., a secondary flash memory) as illustrated in an exploded view of the executable-in-place module 250 in FIG. 3).

Referring back to FIG. 1, the expandable portable solid-state device 150 may be external to the data processing system 100, and may hold data without requiring connection to a power supply. A connector 102 (e.g. a USB port/hub, etc.) may be used to connect the expandable portable solid-state device 150 to the data processing system 100. The expandable portable solid-state device 150 includes an expansion canister 104 and/or an expansion memory 106 as illustrated in the embodiment of FIG. 1. The expansion canister 104 enables the expandable portable solid-state device 150 to increase (e.g., concatenate on to a same partition, and/or enable a new partition) a storage capacity of the expandable portable solid-state device 150 when the expansion memory 106 is coupled (e.g., connected) to the expansion canister 104. In one embodiment, the expansion memory 106 utilizes a memory of a digital audio/video device (e.g., an Apple® iPod® device) to expand the memory of the expandable portable solid-state device 150.

The expandable portable solid-state device 150 is portable in that it may be small enough to be carried around in an adult's pocket (e.g., approximately 6 inches by 6 inches or smaller) and designed as a keyfob and/or as a lanyard. The expandable portable solid-state device 150 is a solid-state device in that it may not include a spinning disk (e.g., as found in a hard drive). Furthermore, in one embodiment, the expandable portable solid-state device 150 may be capable of withstanding shocks up to 3 g or more, such as may be caused if the expandable portable solid-state device 150 is dropped from an elevated position (e.g., such as a 5 story building). In one embodiment, the expandable portable solid-state device 150 is optimized to withstand drops of up to 10 feet in height or more. In addition, according to one embodiment, the expandable portable solid-state device 150, may be packaged to withstand heat at least until 125 degrees Celsius, and may have a mean time between failures of 3 million hours or more.

The expandable portable solid-state device 150 may further include a driver (e.g., executed by the data processing system 100) to instruct the data processing system 100 to boot up from an operating system (e.g., Microsoft® Windows® and/or Apple® OS®) installed on the expandable portable solid-state device 150 (e.g., the operating system may be stored in the expansion memory 106). The driver may be automatically loaded on the data processing system 100 (e.g., through an autoexec program that runs whenever the data processing system 100 detects that it is connected to the expandable portable solid-state device 150) when the expandable portable solid-state device 150 is connected to the data processing system 100.

In addition, the expandable portable solid-state device 150 of FIG. 1 may execute application programs directly without customized optimization for the flash memory 302 (e.g., as illustrated in FIG. 3) and without affecting life of the flash memory 302 (e.g., see FIG. 3) in the executable-in-place module 250 (e.g., see FIG. 2) of the expandable portable solid-state device 150 (e.g., see the exploded view in FIG. 2) As such, application programs may be executed from the dynamic random access memory 304 of FIG. 3 having a mirror image of the data of the flash memory 302 because the dynamic random access memory 304 of FIG. 3 may have a larger capacity for reads/writes than the flash memory 302.

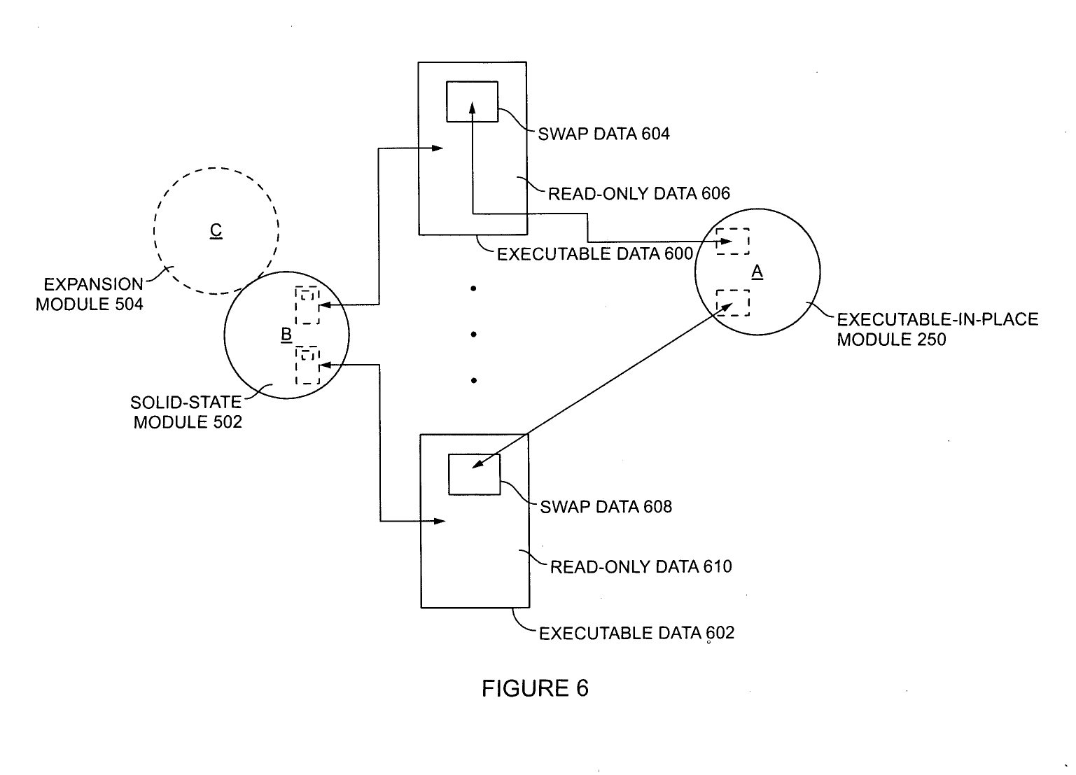

FIG. 2 is a block diagram of the expandable portable solid-state device 150 of FIG. 1 having an executable-in-place module 250, a flash memory 200, the expansion canister 104, and the expansion memory 106, according to one embodiment. The executable-in-place module 250 may be used to store application programs, and/or swap data (e.g., a swap data 604 of FIG. 6) that may be frequently erased and/or rewritten (e.g., as temporary files) by an application program (e.g., Microsoft® Word®). In one embodiment, a driver and/or an application program customized for the expandable portable solid-state device 150 may be installed on the data processing system 100 of FIG. 1 that automatically determines what data is to be stored on the executable-in-place module 250 (e.g., swap data 604 of FIG. 6) and what data is to be stored on the flash memory 200 and/or the expansion memory 106 (e.g., read-only data 606). That way, a number of writes can be minimized on the flash memory 200, and the expandable portable solid-state device 150 may have a longer mean-time-between failure rating (MTBF) because of limitation in the number of writes tolerated by the flash memory 200. In one embodiment, the expansion memory 106 is a hard drive, a digital music storage device, a video storage device, an executable-in-place device, and/or another flash device.

FIG. 3 is an exploded view of the executable-in-place module 250 of FIG. 2 having a flash memory 302, a dynamic random access memory 304, a custom circuit 300, a memory controller 306, and an interface 308, according to one embodiment. In FIG. 3, the executable-in-place module 250 includes the flash memory 302 coupled to the dynamic random access memory 304 through the custom circuit 300. Also illustrated in FIG. 3, the memory controller 306 is connected to the custom circuit 300 to arbitrate and/or transfer data between at least two of the flash memory 302, the dynamic random access memory 304, other memory in the executable-in-place module 250 (e.g., not shown but a cache memory, a hard drive, etc.), and/or a storage in the data processing system 100. In addition, an interface 308 (e.g., a USB interface) connects the executable-in-place module 250 to the data processing system 100 of FIG. 1.

In one embodiment, the dynamic random access memory 304 stores at least as much data as the flash memory 302 (e.g., to enable the entire contents of the flash memory 302 to be transferred to the dynamic random access memory 304). Using the custom circuit 300, the executable-in-place module 250 may copy data from the flash memory 302 to the dynamic random access memory 304 when the executable-in-place module 250 receives power (e.g., may receive power though the interface 308 from the data processing system 100 coupled to the expandable portable solid-state device 150 through the connector 102 as illustrated in FIG. 1). Similarly, when the expandable portable solid-state device 150 no longer receives power, the custom circuit 300 may copy data from the dynamic random access memory 304 to the flash memory 302 of the executable-in-place module 250.

The custom circuit 300 may minimize writes to the flash memory 302 by using the dynamic access memory 304 as a working memory (e.g., a proxy memory) during operation of the data processing system 100 of FIG. 1. The custom circuit 300 may also transfer all data (or a substantial part) of the dynamic random access memory 304 to the flash memory 302 on power down of the data processing system 100. The memory controller 306 may regulate movement of data from the flash memory 302 to the dynamic random access memory 304 (e.g., shutting down at least some portions of the flash memory 302 to conserve power, parity checking, etc.). The memory controller 306 may also maintain a map (e.g., a table) of which blocks are being used by a particular application, and may shut down at least some of the blocks that are not being used by the particular application (e.g., not used for a particular amount of time, etc.).

In one embodiment, the custom circuit 300 disables at least some sectors of the flash memory 302 and/or the dynamic random access memory 304 when the expandable portable solid-state device 150 is in operation (e.g., to conserve power). The expandable portable solid-state device 150 can be connected to the data processing system 100 through the connector 102 (e.g., a USB plug). The custom circuit 300 may receive power from the data processing system 100 of FIG. 1 through the interface 308 (e.g., when the connector 102 is connected to the data processing system 100). The expandable portable solid-state device 150 may have a liquid crystal display (not shown) that provides an indication whether data of the flash memory 302 has been transferred to the dynamic random access memory 304 in one embodiment.

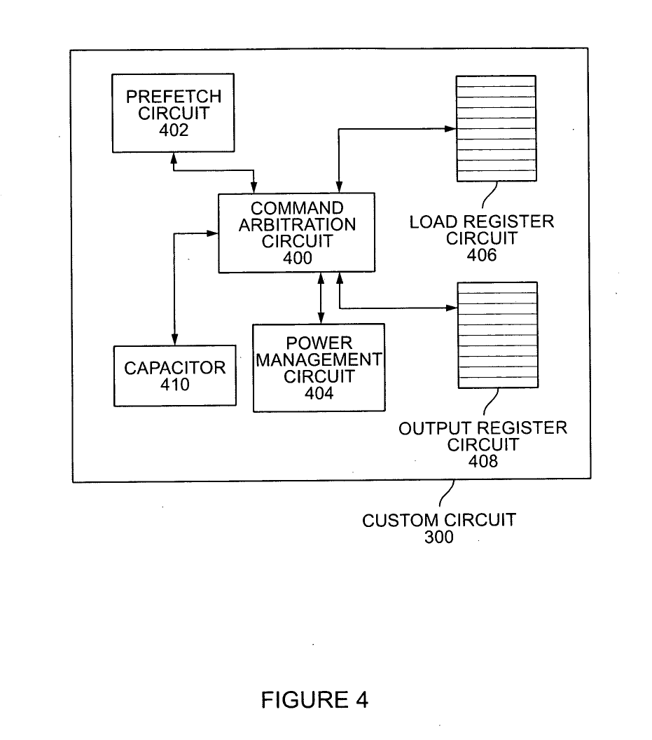

FIG. 4 is a logic circuit view of the custom circuit 300 of FIG. 3 having a pre-fetch circuit 402, a power management circuit 404, a load register circuit 406, an output register circuit 408, and a capacitor 410 coupled (e.g., connected) to a command arbitration circuit 400. The pre-fetch circuit 402 (e.g., a CMOS based logic circuit) may enable the expandable portable solid-state device 150 to transfer of the contents of the flash memory 302 to the dynamic random access memory 304 during a boot up operation. The pre-fetch circuit 402 may increase speed of the boot up operation by loading data blocks in a particular order (e.g., preset by a user of the data processing system 100) from the flash memory 302 to the dynamic random access memory 304 when power is received by the expandable portable solid-state device 150.

For example, the pre-fetch circuit 402 may first load data blocks corresponding to a boot process, so that the expandable portable solid-state device 150 can boot up the data processing system 100 without extra delay (e.g., by prioritizing transfer of data corresponding to the boot process to be copied first from the flash memory 302 to the dynamic random access memory 304 when power is received by the expandable portable solid-state device 150). According to an embodiment, the pre-fetch circuit 402 (e.g., inside the custom circuit 300) may copy sectors from the flash memory 302 (e.g., as illustrated in FIG. 3) in an order based on a prior history of data access by the data processing system 100 of FIG. 1.

The command arbitrator circuit 400 may regulate copying of data between the flash memory 302 and the dynamic random access memory 304 of FIG. 3. The capacitor 410 of FIG. 4 may retain at least some data of the flash memory 302 of FIG. 3 (e.g., a non-volatile device that retains data even without power) in the dynamic random access memory 304 (e.g., a volatile device that loses data when power is no longer received). The capacitor 410 can serve as a means to prevent data from having to be recopied from the flash memory 302 to the dynamic random access memory 304 when power is temporarily (e.g., for 5 minutes, 1 day, etc.) is unavailable to the expandable portable solid-state device 150.

The load register circuit 406 and/or the output register circuit 408 may be used by the pre-fetch circuit 402 to temporarily store information that needs to be copied to/from the flash memory 302 and the dynamic random access memory 304. In addition, the load register circuit 406 may be used by the capacitor 410 to temporarily store information that needs to be retained by the dynamic random access memory 304 as long as possible (e.g., to allow for quick restart, to allow for quick boot up, etc.). In addition, the load register circuit 406 and/or the output register circuit 408 may be used by the command arbitration circuit 400 and/or the power management circuit 404 to temporarily buffer data that needs to be transferred between at least two of the flash memory 302, the dynamic random access memory 304, and/or the data processing system 100.

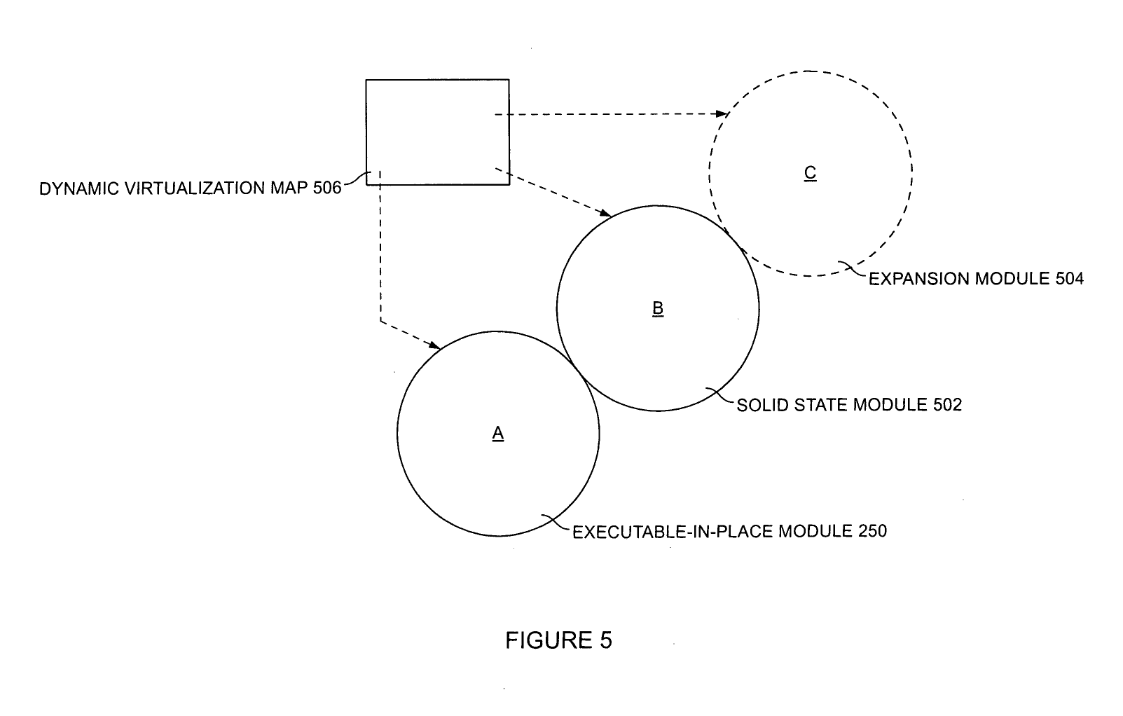

FIG. 5 is a logic view of a dynamic virtualization map 506 associated with the executable-in-place module 250 (e.g., as described in detail in FIG. 2, FIG. 3, and FIG. 4), a solid-state module 502, and an expansion module 504, according to one embodiment. In FIG. 5, a dynamic virtualization map 506 may be a memory map that automatically constructs an architecture of where data is stored when the expansion module 504 is added/removed from the expandable portable solid-state device 150. Furthermore, the dynamic virtualization map 506 may use a fault tolerant algorithm (e.g., a RAID algorithm) to store multiple copies of data across memory blocks (e.g., using parity data) of the executable-in-place module 250, the solid state module 502, and/or the expansion module 504.

The solid-state module 502 may be the flash memory 200 as illustrated in FIG. 2. The solid-state module 502 may be a preferred location to store data that is read-only data, because number of write operations on the solid state module 502 (e.g., the flash memory of FIG. 2) may be limited by physical properties of the solid-state module 502. By storing read-only data on the solid state module 502, the number of write operations on the solid state module 502 can be minimized. The dynamic virtualization map 506 may automatically allocate data to be stored in the executable in place module 250 and/or the solid state module 502 based on whether the data is frequently erased and/or rewritten (e.g., a swap data) in one embodiment. For example, a particular application program (e.g., Microsoft® Excel®) may include a majority of data that is read only (e.g., instructions that must be executed to perform standard operations of Microsoft® Excel®) and a temporary data (e.g., a swap data) that may store preferences, buffered instructions, and/or auto-recovery information for Microsoft® Excel®. As such, the dynamic virtualization map 506 may automatically determine (e.g., using a driver program installed on the data processing system 100) what data is to be stored in the executable-in-place module 250 (e.g., the swap data and/or the temporary data, because the executable-in-place module 250 may allow for a greater number of write operations as described in FIG. 2, FIG. 3, and FIG. 4), and what data is to be stored in the solid-state module 502 and/or the expansion module 504 (e.g., read only data).

In FIG. 5, the expansion module 504 (e.g., the expansion memory 106 of FIG. 1) may be another flash device, a hard drive, another executable-in-place module, or so forth that is coupled to the expandable portable solid state device 150 using the expansion canister 104 in FIG. 1. In one embodiment, the expansion module 504 is a digital audio/video player (e.g., an Apple® iPod®) whose storage capacity is automatically concatenated to the solid state module 502 (e.g., a driver in the data processing system 100 may allocate all and/or a portion of the storage blocks in the Apple® iPod® as additional memory space for the solid state module 502 using the dynamic virtualization map 506). For added security, in one embodiment, the expansion module 504 must be present for an application program to operate in the expandable portable solid-state device 150 (e.g., the expansion module 504 may serve as a hardware security key, and/or data blocks for a particular application may be spread across the expansion module 504, the solid state module 502 and/or the executable-in-place module 250). In another embodiment, the expansion module 504 is a separate partition, which is distinctly and separately recognized as another partition (e.g., a separate logical volume) by the data processing system 100 (e.g., a user may set one or more parameters that govern an operation and/or functionality of the various modules illustrated in FIG. 5 using the dynamic virtualization map 506).

FIG. 6 is a segmentation view of an allocation of swap data (e.g., a swap data 604 and/or a swap data 608) to the executable-in-place module 250 and an allocation of read-only data (e.g., a read-only data 606 and/or a read-only data 610) to the solid-state module 502 and/or the expansion module 504, according to one embodiment. Illustrated in FIG. 6, is an executable data 600 (e.g., an application program such as Microsoft® Word®) and an executable data 602 (e.g., an application program such as Adobe® Illustrator®). The executable data 600 includes the swap-data 604 and/or the read-only data 606. The executable data 602 includes the swap data 608 and/or the read-only data 610. In FIG. 6, the swap data 604 and the swap data 608 is illustrated as being allocated (e.g., using the dynamic virtualization map 506 of FIG. 5) to the executable-in-place module 250 (e.g., because the executable-in-place module 250 may be more tolerant to the frequent read/write operations of the swap data). In FIG. 6, the read-only data 606 and the read-only data 610 are illustrated as being allocated (e.g., using the dynamic virtualization map 506 of FIG. 5) to the solid-state module 502 and the expansion module 504 (e.g., because the solid-solid state module 502 and the expansion module 502 may be more susceptible to failure because of excessive write operations).

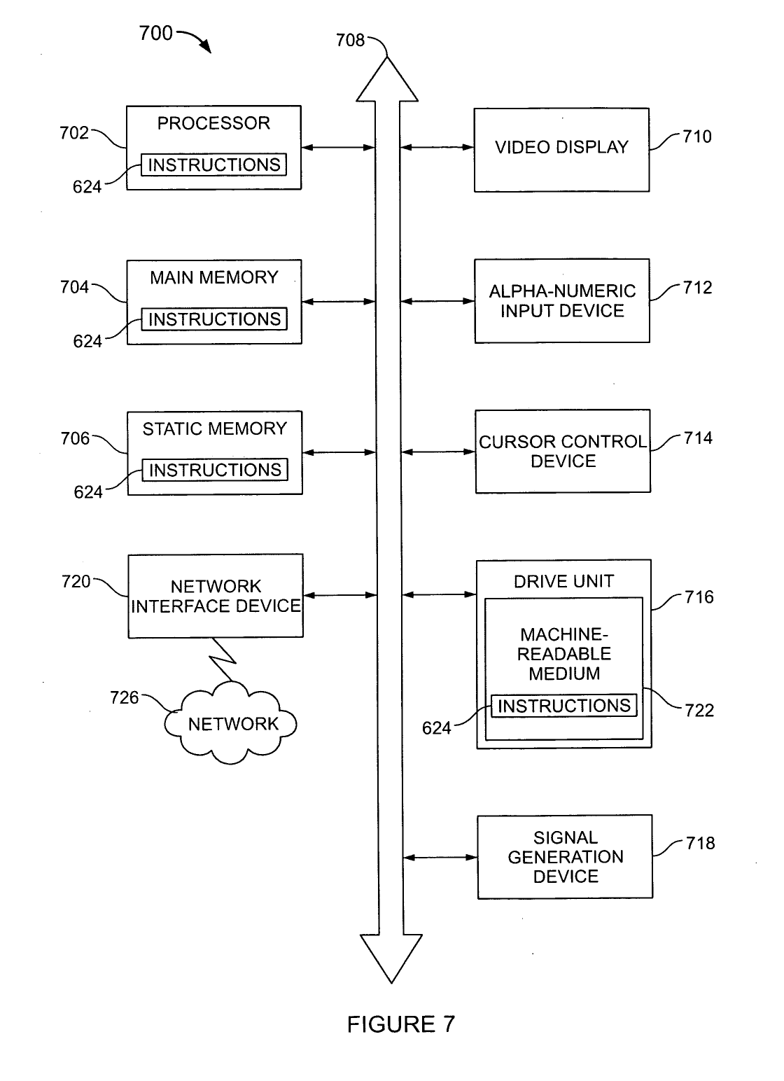

FIG. 7 is a diagrammatic representation of a machine in an example form of a computer system 700 in which there are a set of instructions, for causing the machine to perform any one or more of the methodologies discussed herein may be executed, according to one embodiment. FIG. 7 shows a diagrammatic representation of the machine in the computer system 700 (e.g., a laptop computer, the data processing system 100 of FIG. 1, etc.) within which a set of instructions, for causing the machine to perform any one or more of the methodologies discussed herein, may be executed. In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment. The machine may be a personal computer (PC), a tablet PC, a laptop computer, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The computer system 700 may include a processor 702 (e.g., a central processing unit (CPU), a graphics processing unit (GPU), and/or both), a main memory 704, and a static memory 706, which communicate with each other via a bus 708. The computer system 700 may further include a video display unit 710 (e.g., a liquid crystal display (LCD) and/or a cathode ray tube (CRT)), an alphanumeric input device 712 (e.g., a keyboard), a cursor control device 714 (e.g., a mouse), a disk drive unit 716, a signal generation device 718 (e.g., a speaker) and a network interface device 720.

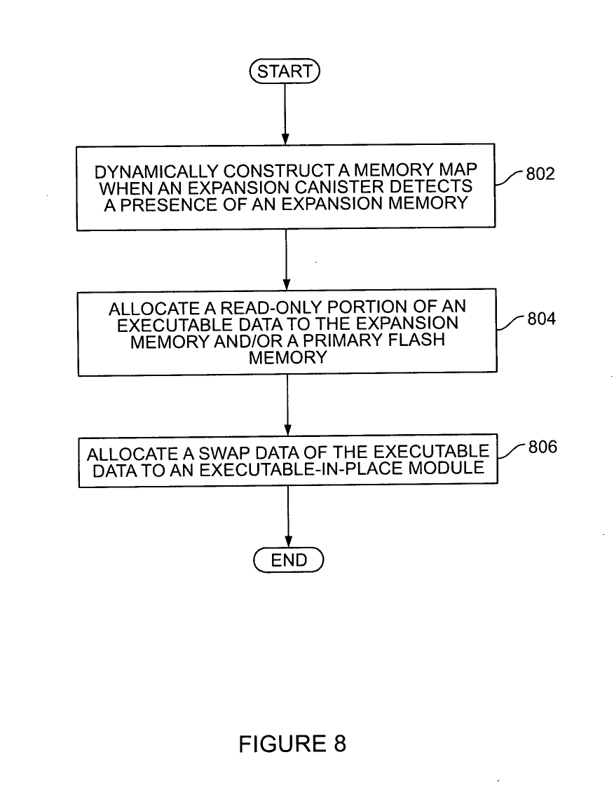

The disk drive unit 716 (e.g., a hard drive) may include a machine-readable medium 722 on which is stored one or more sets of instructions (e.g., software 724) embodying any one or more of the methodologies and/or functions described herein. The software 724 may also reside, completely and/or at least partially, within the main memory 704 and/or within the processor 702 during execution thereof by the computer system 700, the main memory 704, and the processor 702 also constituting machine-readable media. The software 724 may further be transmitted and/or received over a network 726 via the network interface device 720. FIG. 8 is a process flow to dynamically construct a memory map (e.g., the dynamic virtualization map 506 of FIG. 5), according to one embodiment. In operation 802, the memory map (e.g., the dynamic virtualization map 506 of FIG. 5) is dynamically (e.g., created in response to an additional memory added to the expandable portable solid-state device 150 through the expansion canister 104 of FIG. 1) constructed when an expansion canister (e.g., the expansion canister 104 of FIG. 1) detects a presence of an expansion memory (e.g., the expansion memory 106 of FIG. 1).

In operation 804, a read-only portion (e.g., the read only data 606 of FIG. 6) of an executable data (e.g., the executable data 600 of FIG. 6) is allocated to the expansion memory and/or a primary flash memory. In operation 806, a swap data (e.g., the swap data 604 of FIG. 6) of the executable data (e.g., the executable data 600 of FIG. 6) is allocated to an executable-in place module (e.g., the executable-in-place module 250 of FIG. 2 and of FIG. 6). The read only data (e.g., the read only data 606 of FIG. 6) and/and the swap data (e.g., the swap data 604 of FIG. 6) may be allocated in a predetermined order based on a prior history of access by the data processing system (e.g., the data processing system 100 of FIG. 1). The data processing system (e.g., the data processing system 100 of FIG. 1) may begin accessing the data of the executable-in-place module (e.g., the executable-in-place module 250 of FIG. 2) upon boot up of a data processing system (e.g., the data processing system 100 of FIG. 1).

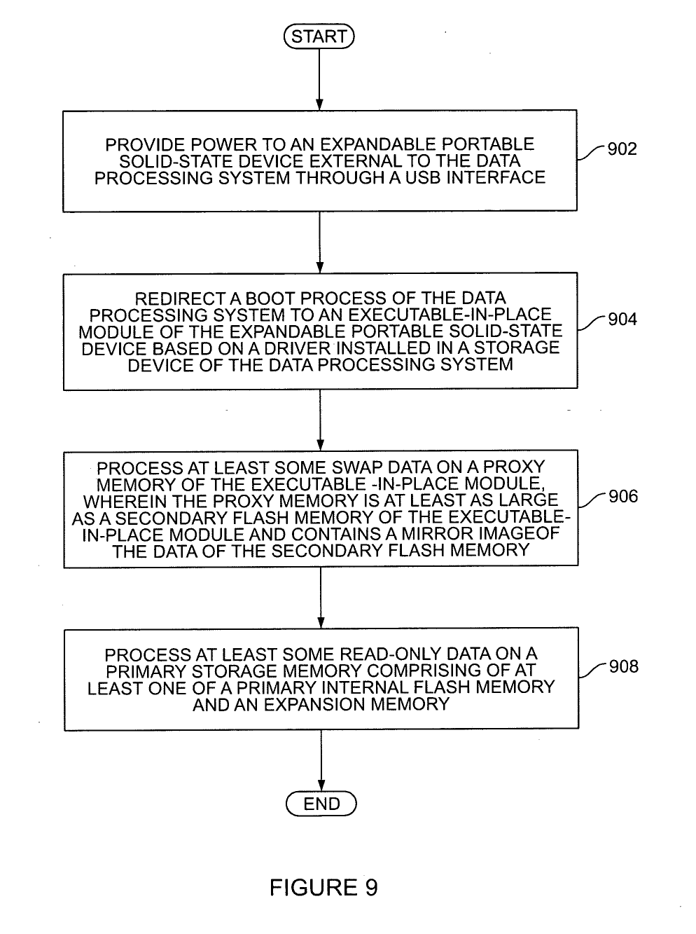

FIG. 9 is a process flow to redirect a boot process of a data processing system (e.g., the data processing system 100 of FIG. 1) to an executable-in-place module (e.g., the executable-in-place module 250 of FIG. 2), according to one embodiment. In operation 902, power is provided to an expandable portable solid-state device (e.g., the expandable portable solid-state device 150 of FIG. 1) external to the data processing system (e.g., the data processing system 100 of FIG. 1) through a USB interface (e.g., the connector 102 of FIG. 1). In operation 904, a boot process of the data processing system (e.g., the data processing system 100 of FIG. 1) is redirected to an executable-in-place module (e.g., the executable-in-place module 250 of FIG. 2) of the expandable portable solid-state device (e.g., the expandable portable solid-state device 150 of FIG. 1) based on a driver installed in a storage device of the data processing system (e.g., the data processing system 100 of FIG. 1).

In operation 906, at least some swap data (e.g., the swap data 604 of FIG. 6) is processed on a proxy memory (e.g., the DRAM 304 of FIG. 3) of the executable-in-place module (e.g., the executable-in-place module 250 of FIG. 2). The proxy memory (e.g., the DRAM 304 of FIG. 3) may be at least as large as a secondary flash memory (e.g., the flash memory 302 of FIG. 3) of the executable-in-place module (e.g., the executable-in-place module 250 of FIG. 2) and may contain a mirror image of data of the secondary flash memory (e.g., the flash memory 302 of FIG. 3).

In operation 908, at least some read-only data (e.g., the read only data 606 of FIG. 6) is processed on a primary storage memory (e.g., a primary internal flash memory such as the flash memory 200 of FIG. 2 and/or an expansion memory such as the expansion memory 106 of FIG. 1 and FIG. 2). The expansion memory (e.g., the expansion memory 106 of FIG. 1 and FIG. 2) may be concatenated to the primary internal flash memory (e.g., the flash memory 200 of FIG. 2) to provide security to data of the expandable portable solid-state device (e.g., security may be provided because an application program and/or a data file may only execute when a unique and/or particular expansion memory 106 of FIG. 1 is installed in the expandable portable solid state device 150).

For example, a particular data file and/or application program may have data bits/blocks stored across both internal memory (e.g., the flash memory 200 and/or the executable-in-place module 250 of the expandable portable solid state device 150 of FIG. 2) and in the expansion memory (e.g., the expansion memory 106 of FIG. 2). In an alternate embodiment, the expansion memory (e.g., the expansion memory 106) may be a separate logical volume (e.g., registered as a separately partitioned storage device) to the primary internal flash memory (e.g. the flash memory 200 of FIG. 2) to provide flexibility to the expandable portable solid-state device (e.g., the expandable portable solid-state device 150 of FIG. 1).

The term “machine-readable medium” shall also be taken to include any medium that is capable of storing, accessing. encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

Although the present embodiments have been described with reference to specific embodiments, it will be evident that various modifications and changes may be made to these embodiments without departing from the broader spirit and scope of the invention. For example, the various circuits described herein may be preformed and created using software (e.g., programming code, programming instructions, etc.) in addition to hardware circuitry (e.g., CMOS based logic circuitry).

For example, the custom circuit 200 that includes the pre-fetch circuit 402, the command arbitration circuit 400, the load register circuit 406, the output register circuit 408 and the power management circuit 404 may be embodied using transistors, logic gates, and electrical circuits (e.g., application specific integrated circuitry (ASIC)), as well as in software modules (e.g., a custom module that includes a pre-fetch module, a command arbitration module, a load register module, an output register module and a power management module). In addition, it should be noted that the executable-in-place module 250, the solid state module 502, the dynamic virtualization map 506, and/or the expansion module 504 may be implemented in software and/or using hardware circuitry (e.g., CMOS based circuitry having transistors), using an executable-in-place circuit, a solid state circuit, a dynamic virtualization circuit, and/or an expansion circuit.

In addition, it will be appreciated that the various operations, processes, and methods disclosed herein may be embodied in a machine-readable medium and/or a machine accessible medium compatible with a data processing system (e.g., a computer system). Accordingly, the specification and drawings are to be regarded in an illustrative rather than a restrictive sense.

What is claimed is:

1. A solid-state device, comprising:
an expansion canister to enable coupling of a flash memory of the solid-state device to an external storage memory; and
an executable-in-place module of the solid state device coupled to the flash memory to process a swap data to minimize a number of write operations in the flash memory.

2. The solid-state device of claim 1, wherein the executable-in-place module includes a secondary flash memory coupled to a dynamic random access memory, wherein the dynamic random access memory to store at least as much data as the secondary flash memory; and wherein a logic circuit coupled to the secondary flash memory and the dynamic random access memory to copy data from the secondary flash memory to the dynamic random access memory on power up of a data processing system coupled to the solid-state device.

3. The solid-state device of claim 2, wherein the logic circuit is to minimize writes to the secondary flash memory by using the dynamic access memory as a working memory during operation of the data processing system.

4. The solid-state device of claim 3, wherein the logic circuit is to block at least some sectors of at least one of the secondary flash memory and the dynamic random access memory when the data processing system uses the working memory to conserve power usage of the solid-state device.

5. The solid-state device of claim 2, wherein the logic circuit is to transfer all data in the dynamic random access memory to at least one of the flash memory and the secondary flash memory on power down of the data processing system.

6. The solid-state device of claim 2, wherein a liquid crystal display is to indicate that the solid-state device is operable when data of the secondary flash memory is copied to the dynamic random access memory.

7. The solid-state device of claim 2, further comprising a capacitor of the executable-in-place module to retain at least some data of the flash memory in the dynamic random access memory upon power down of the data processing system, and wherein the logic circuit is to copy sectors from the secondary flash memory in an order based on a prior history of data access by the data processing system.

8. The solid-state device of claim 1, wherein the external storage memory is in a form of a universal serial bus (USB) hard drive coupled through the expansion canister.

9. The solid-state device of claim 1, wherein the solid-state device is a portable device external to the data processing system.

10. The solid-state device of claim 9, wherein the portable device is at least one of a keyfob and a lanyard.

11. The solid-state device of claim 1, wherein the solid-state device is packaged to withstand heat at least until 125 degrees Celsius, and has a mean time between failures of 3 million hours.

12. The solid-state device of claim 1, wherein the solid-state device is coupled to the data processing system through a USB connector.

13. The solid-state device of claim 1, an application program is to execute directly from the solid-state device without customized optimization of the solid-state device.

14. The solid-state device of claim 1, further comprising a driver of the data processing system to instruct the data processing system to boot up the data processing system from an operating system whose read-only data is executable from the flash memory and whose swap data is executable from the executable-in-place module.

15. The solid-state device of claim 14, wherein the driver is automatically loaded on the data processing system when the solid-state device is connected to the data processing system.

16. A method comprising:
dynamically constructing a memory map when an expansion canister detects a presence of an expansion memory;
allocating a read-only portion of an executable data to at least one of the expansion memory and a primary flash memory; and
allocating a swap data of the executable data to an executable-in place module.

17. The method of claim 16, wherein the read-only portion and the swap data are allocated in a predetermined order based on a prior history of access by a data processing system, and wherein the data processing system begins accessing data of the executable-in-place module upon boot up of the data processing system.

18. A machine readable method of a data processing system, comprising:
providing power to an expandable portable solid-state device external to the data processing system through a USB interface;
redirecting a boot process of the data processing system to an executable-in-place module of the expandable portable solid-state device based on a driver installed in a storage device of the data processing system;
processing at least some swap data on a proxy memory of the executable-in-place module, wherein the proxy memory is at least as large as a secondary flash memory of the executable-in-place module and contains a mirror image of data of the secondary flash memory; and
processing at least some read-only data on a primary storage memory comprising of at least one of a primary internal flash memory and an expansion memory.

19. The method of claim 18, wherein the expansion memory is concatenated to the primary internal flash memory to provide security to data of the expandable portable solid-state device.

20. The method of claim 18, wherein the expansion memory is a separate logical volume to the primary internal flash memory to provide flexibility to the expandable portable solid-state device.
